(19) United States
(12) Patent Application Publication
(10) Pub. No.: US 2008/0307498 A1
(43) Pub. Date: Dec. 11, 2008

(54) ACCESS CONTROL FOR SERVER-BASED GEOGRAPHIC INFORMATION SYSTEM

(75) Inventors: Carla Johnson, Boulder, CO (US); Brian Myller, Arvada, CO (US); John Roth, Boulder, CO (US); Russell Huff, Lyons, CO (US); Paul Sellards, Littleton, CO (US); Cedar Cox, Fredrick, CO (US)

Correspondence Address: HENSLEY KIM & HOLZER, LLC, 1660 LINCOLN STREET, SUITE 3000, DENVER, CO, 80264, US

(73) Assignee: Waterstone Environmental Hydrology & Engineering, Inc., Boulder, CO (US)

(21) Appl. No.: 11/965,567

(22) Filed: Dec. 27, 2007

Related U.S. Application Data
(60) Provisional application No. 60/882,070, filed on Dec. 27, 2006.
(60) Provisional application No. 60/882,095, filed on Dec. 27, 2006.
(60) Provisional application No. 60/882,126, filed on Dec. 27, 2006.

(51) Int. Cl. G06F 21/00

(52) U.S. Cl. 726/3

(57) ABSTRACT

A number of geospatial attributes or parameters associated with GIS data are used to filter requests for geo-visualization of the data and to determine whether the request is subject to a restriction. Access to GIS data may be controlled for a variety of reasons including security concerns, proprietary concerns, or merely to generate revenue for a particular data source. In an open or public platform, contributors of GIS data accessible for geo-visualization may place limits or restrictions on the availability of or accessibility of the GIS data. The contributor may tag or otherwise encode an entire dataset or portions of the dataset with restriction instructions associated with one or more geospatial attributes. In a public platform, access to data is controlled based upon the geospatial attributes, for example, the geospatial location (coordinates) of a map tile request, scale of a map tile request, resolution of a map tile request, payment for access, the combination of layers requested, or freshness or staleness of data requested.

### CROSS REFERENCE TO RELATED APPLICATIONS

This application claims priority pursuant to 35 U.S.C. § 119(e) to U.S. provisional application No. 60/882,070, filed 27 Dec. 2006, and entitled “Scalable server-side layer access control for decision management system”; U.S. provisional application No. 60/882,095, filed 27 Dec. 2006, and entitled “Data filter for decision management system”; and U.S. provisional application No. 60/882,126, filed 27 Dec. 2006, and entitled “Star conversion tool for decision management system”; each of which is hereby incorporated herein by reference in its entirety.

This application is related to U.S. patent application Ser. No. 11/749,720 filed 16 May 2007 and entitled “State saver/restorer for a geospatial decision management system,” which is hereby incorporated herein by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. W912BV-06-D-2008 awarded by the Department of Army Corps of Engineers and by the terms of Contract No. FA8903-04-F-8889 awarded by the Department of the Air Force.

### BACKGROUND

Geographic information system (GIS) applications are part of a computer technology for capturing, storing, analyzing and managing data and associated attributes that are spatially referenced to the Earth (or other mapped geography). Generally, a GIS application can integrate, store, edit, analyze, share, and display geographically-referenced information. More specifically, a GIS application can allow a user to view maps, create interactive queries (e.g., user created searches), analyze spatial information, edit geographically-referenced data, and present the results from all these operations. A GIS application can also link information or attributes to location data, such as people to addresses, buildings to parcels, or streets within a transportation network. A GIS user can then layer that information to provide an integrated view of the information relative to a map so as to develop a better understanding of how the many different variables interrelate or work together.

In standard GIS systems, geographically-referenced information is maintained confidential and protected datastores by the creators or collectors of such data. Access to information in the datastores is controlled and provided directly by the creator or owner. Without knowledge of the source or location of particular geographically-referenced information and a password or certificate to access the information, the information is inaccessible. Integration of geographically-referenced information to provide an integrated interface or view of the information in context with a geographic map is usually performed at a user's computer using sophisticated GIS software. Alternatively, a user may interface with a server device managed by the creator through a client device running specialized software applications to interact with the GIS databases of the data creators. At present access to data in a public forum is generally restricted by standard network security measures such as digest authentication and certificates.

The information included in this Background section of the specification, including any references cited herein and any description or discussion thereof, is included for technical reference purposes only and is not to be regarded subject matter by which the scope of the invention is to be bound.

### SUMMARY

It may be desirable to control access to GIS data for a variety of reasons, for example, security concerns, proprietary concerns, or merely to generate revenue for a particular data source. In turn, a number of geospatial attributes or parameters associated with GIS data may be used to filter requests for geo-visualization of the data and determine whether the request is subject to a restriction. In an open or public platform, contributors of GIS data accessible for geo-visualization may place limits or restrictions on the availability of or accessibility of the GIS data. In order to place access restrictions on data, the contributor may tag or otherwise encode an entire dataset or portions of the dataset with restriction instructions associated with one or more geospatial attributes. In such a public platform, access to data may be controlled based upon such geospatial attributes, for example, the geospatial location (coordinates) of a map tile request, scale of a map tile request, resolution of a map tile request, payment for access, the combination of layers requested, or freshness or staleness of data requested.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is a schematic diagram of an exemplary implementation of a geospatial decision management system for implementing a geographic information system over a network.

FIG. 2 is a schematic diagram of a geospatial decision management system depicting exemplary implementations of technical and management interface tools available to a client user.

FIG. 3 is a schematic diagram of additional components of a geospatial decision management system for implementing access control to presentation of geospatial attributes within a network.

FIG. 4 is a flow diagram of exemplary operations for implementing access control to presentation of geospatial attributes within a geospatial decision management system.

FIG. 5 is a schematic diagram of an exemplary implementation of a general purpose computer system that that may be used to implement various aspects of a geospatial decision management system, including access control.

### DETAILED DESCRIPTION

A geographic information system (GIS) is a computer technology that provides an analytical framework for managing and integrating data, solving problems, or understanding past, present, or future situations. A GIS can link information or attributes to location data (hereinafter referred to as a “feature”), for example, people to addresses, buildings to parcels, or streets within a network. A GIS may further layer such information to present a better or clearer understanding of how many different variables interrelate or work together. Layers may be in the form of colored or textured overlays, graphics, icons, graphs, or other visual indicators of data in context with a geographic location associated with the data.

A GIS is most often associated with maps formed within a framework of a common coordinate system, such as the World Geodetic System 1984 (WGS84). Reference locations within the framework may be specified by or translated to or from locations defined within a common coordinate system, so as to allow integration of disparate data and functionality with a geospatial browser. A map, however, is only one way a user can work with geographic data in a GIS and is only one type of output generated by a GIS. Furthermore, a GIS can provide many more problem-solving capabilities than using a simple mapping program or adding data to an online mapping tool (e.g., in a “mash-up”).

Generally, a GIS can be viewed in at least three ways, (1) as a database; (2) as a map; or (3) as a model. As a database, a GIS provides a unique kind of database relating to the Earth or other mapped region, such as a geographic database or geo-database. Fundamentally, a GIS is based on a structured database that describes the mapped region in geographic terms. GIS maps may be either two or three dimensional in presentation. GIS maps are generally constructed of “tiles” that are unit areas of a geographic region. Tiles may be identified in the database by coordinate boundaries or individual reference identifications allocated to each tile. The number of tiles covering a particular geographic region will vary depending upon the resolution of the map requested; a high resolution map (e.g., 1 m) of a geographic area will have substantially more tiles than a lower resolution map of the same area. Maps combining the underlying geographic information with overlays of associated data can be constructed and used as “windows into the database” to support queries, analysis, and editing of the information in a process called “geo-visualization.” As a model, a GIS is a set of information transformation or “geo-processing” tools that derive new geographic datasets from existing datasets. This geo-processing functionality can take information from existing datasets, apply analytic functions, and write results into new derived datasets that show features and feature relationships with the mapped region and present the results to a user.

A GIS allows mapping of locations and things and identification of places with requested features. GIS mapping may provide information about individual feature or present a distribution of features on a map to identify patterns. GIS mapping may be based upon or filtered by quantities, for example, locations of most and least of a feature. GIS mapping may also find and establish relationships between places, features, conditions, or events and determine where certain criteria are met or not met. GIS mapping may also present densities to view concentrations. A density map allows measurement of a number of features using a uniform area unit, such as acres or square miles, to clearly present the distribution. This functionality provides an additional level of information beyond simply mapping the locations of features.

GIS may also be used to depict events occurring within or nearby an area. For example, a district attorney might monitor drug-related arrests to find out if an arrest is within 1,000 feet of a school; if so, stiffer penalties may apply. GIS may be used to determine items within a set distance of a feature by mapping an area within a range of the feature. GIS may also be used to map the change in an area to anticipate future conditions, decide on a course of action, or to evaluate the results of an action or policy. By mapping where and how things move over a period of time, insight into trends or behaviors may be gained. For example, a meteorologist might study the paths of hurricanes to predict where and when they might occur in the future.

GIS may be used to map changes to anticipate future needs. For example, a police chief might study how crime patterns change from month to month to help decide where officers should be assigned. GIS may also be used to map conditions before and after an action or event to see the impact. For example, a retail analyst might map the change in store sales before and after a regional ad campaign to see where the ads were most effective.

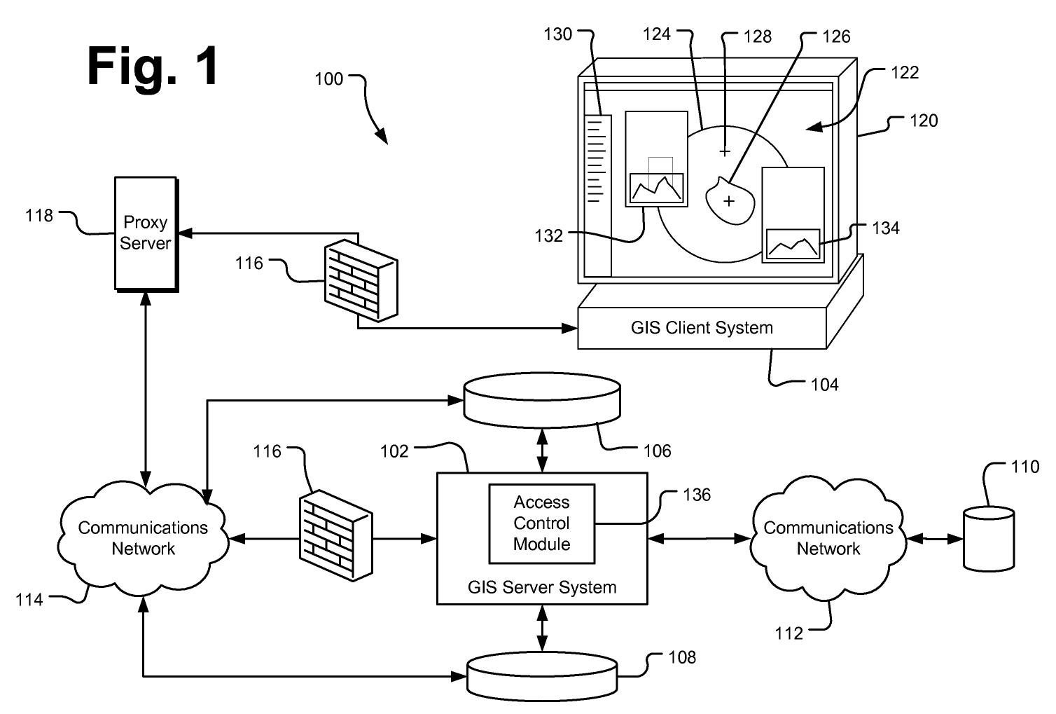

A GIS may be implemented in a geospatial decision management system (GDMS) 100, shown in FIG. 1, to provide the geo-processing power and infrastructure to process the data and render geo-visualizations of the data in a user interface. The GDMS 100 of FIG. 1 may be implemented in a combination of a server computer system 102, one or more client computer systems 104, and various data sources 106, 108, and 110. GDMS data may be saved in the GDMS server system 102 and/or in a datastore 106, 108, and 110 at a local or remote location. The data sources 106 and 108 are depicted as local to the server system 102, whereas the data source 110 is depicted as coupled remotely to the server system 102 via a communications network 112. GDMS data may also be cached in a proxy server.

The client system 104 may be coupled remotely to the server system 102 via a communication network 114 (or alternatively, the same communications network 112), although a local connection between the client system 104 and the server system 102 may be employed. It should be understood that multiple client systems may be coupled with the server system 102 concurrently. It should also be understood that the client system 104 and server system 102 may be implemented in an integrated system. The network connection 114, such as an Internet connection, may be used by GDMS client systems 104 to access the data (e.g., data defining layers or providing financial information, chemical concentrations, test results, project state reports, etc.) at the remote data sources 106, 108, 110, directly or through an intermediate computing system (e.g., a proxy server or GDMS server).

The client computer 104 may be coupled to an intermediate server, such as a proxy server 118. The proxy server 118 may be positioned between the client computer 104 and the server system 102. The proxy server 118 intercepts all requests to the server system 102 to see if it can fulfill the requests itself with cached data from prior requests. If not, the proxy server 118 forwards the request to the server system 102 to be fulfilled. The proxy server 204 may also be coupled to the communications network 114 and accessed by the client computer 104 and the server system 102 via the network 114. Firewalls 116 may also be implemented between the server system 102 and the client computer 104 and the network 114 for an added layer of security.

The connection may be established as a secure connection between the client system 104 and the server 102 and/or the remote data sources 106, 108 and 110. The secure connection may be accomplished by a variety of different methods including, but not limited to, authentication codes and passwords, secure user management tools, firewalls, user authentication, secure user management tools, user pathway mapping and/or encryption, etc. In another example, the server system 102 may include an administrative website that may allow authorized users to manipulate and assign user rights (e.g., an administrative tier). The server system 102 may also include a security feature, for example, an access control module 136 to establish, control, and monitor access by client computers 104 to certain data stored within or accessible within the GDMS 100. Access control may be governed by an administrator or it may be an automated function of the access control module 136 based upon attributes of the data requested and permissions held by the user as further described below.

The server system 102 may represent one or more hardware and software servers providing multiple server functions. In addition, one or more of the server system 102, the client system 104, and the databases 106, 108 and 110 may form an N-tier system. The server system 102 may also include a web server application subsystem, whereby World Wide Web-enabled applications may provide various aspects of functionality of the GDMS 100. For example, the server system 102 may provide a website where content creators or generators can upload geospatially-related data that can be transformed into features referenced to locations within a map of the GDMS 100 for access through the client system 104 connected to the GDMS 100 for geo-visualization of the information. In an alternative implementation, the client system 104 may be implemented as a “thick” client and execute client-installed software for some or all of the functionality of the GDMS 100.

A monitor 120, coupled to the client system 104, presents a GDMS interface 122 constructed from data and functionality received through the server system 102. When a user is working within a GDMS 100, s/he is said to be in a GDMS session. The GDMS interface 122 may be generated by a GDMS application executing on the client system 104 or alternatively through a server-executed GDMS application that provides the interface components over the network to a dumb terminal or a browser application running on the client system 104. The GDMS interface 122 may be a geospatial browser window including a map 124 (e.g., a globe in this illustration), a geo-visualization of data as a layer 126 and individual features 128 on the map 124, a layer manager 130 for selecting data and other features from the databases 106, 108, 110. The GDMS view may also include tool palettes 132 and 134, which can be distinct features of the browser interface, browser plug-ins, or separate utilities or applications.

In one implementation, the GDMS interface 122 may be in the form of a geospatial browser window and one or more geospatially-referenced tools. Access to the data or functionality is provided by geospatially-referenced tools (e.g., tool palettes 132 and 134) that are associated with and triggered in relation to a specific location in a common coordinate system (e.g., WGS84 or some other shared coordinate system) shared by the tools and the geospatial browser. For example, a tool may provide chemical analysis results pertaining to soil samples taken from the location over time. In another example, a tool may retrieve and analyze financial data pertaining to a construction project on a specified region on the map (e.g., a location). The data available to such tools is provided from a variety of data sources and associated with each location within the common coordinate system of the GDMS system 100, such as through specified coordinates (e.g., longitude and latitude), other geographic constraints, or organizational constraints (e.g., a project identifier of a project having a specific geographic location or constraint, a feature identifier of a feature having a specific geographic location or constraint, etc.). In this manner, the user can view a location through the geospatial browser and access data and/or functionality associated with a location that is accessible through the tools in the browser. These locations may be the same location or distinct locations.

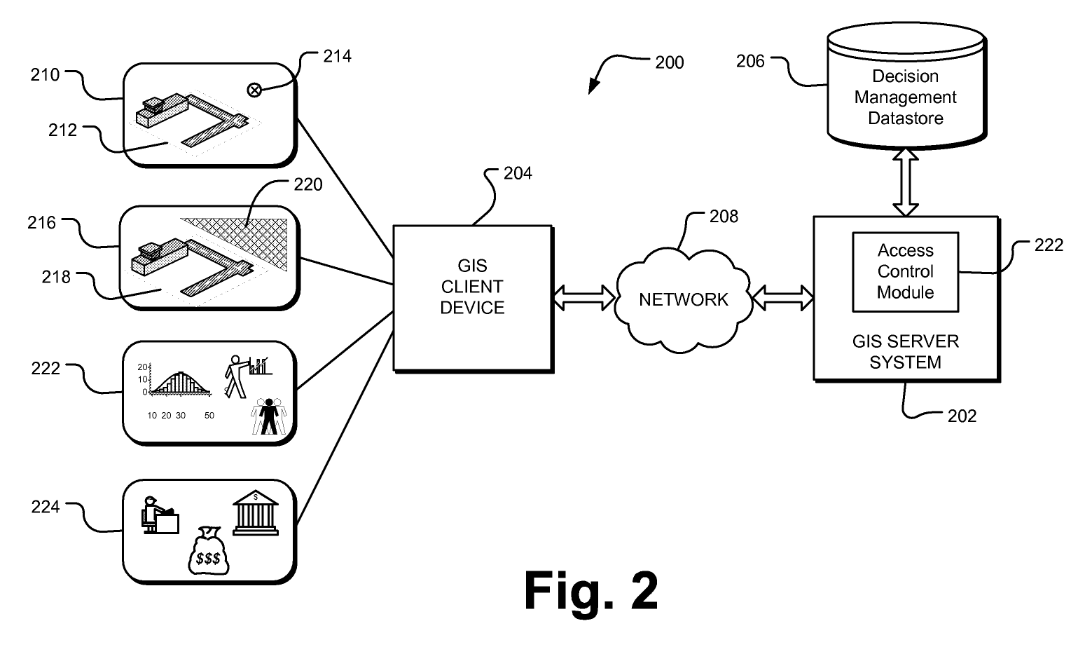

FIG. 2 further illustrates an example of a GDMS 200 for accessing specific data or information within a database based on the association of the information with geospatial coordinates. Again, the GDMS 200 may be implemented by a GIS server system 202 in communication with a GIS client computer 204 over a communication network 208, e.g., the Internet. The GIS client computer 204 may be used to access information in a decision management datastore (DMD) 206 connected with the GIS server system 202. The communication network 208 ideally provides the GIS client computer 204 with high-speed access to indexed data on the DMD 206.

The GIS server system 202 may also include a security feature, for example, an access control module 222 to establish, control, and monitor access by GIS client computers 204 to certain data stored within or accessible via the DMD 206. Access control may be governed by an administrator or it may be an automated function based upon attributes of the data requested and permissions held by the user as further described below

The data retrieved from the DMD 206 may be presented in a user interface 210, 216, 222, 224 (of which four exemplary configurations are presented in FIG. 2) at the GIS client computer 204. A feature presented in the user interface 210 (e.g., a geospatial coordinate or geographic location) on the client computer 204 may be used to access information indexed by features using the DMD 206.

The GIS client computer 204 may access the indexed data in the DMD 206 by using applications or plug-ins, such as technical interfaces 210, 216 and management interfaces 222, 224. The technical interfaces 210, 216 may be used to access technical data associated with particular features. In exemplary implementations such technical data might be biochemical, geochemical, hydro-geological, or other physical data on analytes. The management interfaces 118, 120 may be used to access business management data. In exemplary implementations such management data might be business and organizational documents and data associated with particular features. Several examples of the use of such tools to interface with the DMD 206 and extract the data are presented below.

As shown in the first technical interface 210 in FIG. 2, if the GIS client computer 204 requests information about a particular feature, such as a ground water well located near an airport 212, the GIS client computer 204 may select the feature 214, i.e., the ground water well, to receive information related to that feature 214. The first technical interface 210 may include a concentric area data tool that may provide technical data related to the ground water well feature 214, for example, latitude and longitude, physical inspection data, water level information, and water contamination information, in a the form of information windows and visual geographic information overlays on a base location map. In an alternate implementation shown in the second technical interface 216, technical data concerning an area of land 220 around, adjacent, or near the airport 218 at the location of the feature 214, for example, landscaping, slope, soil composition, or grading information may be presented.

In a further implementation shown in a first management interface 222, a contract management concentric data tool may provide management data based upon the selected feature 214, for example, information on construction or work in progress, zoning or easement information, or information on any contracts applicable to the feature 214. In a further implementation shown in a second management interface 224, a finance management concentric data tool 120 may also provide management data relating to financial information applying to the feature 214 selected, for example, costs of past repairs or current maintenance fees. In some implementations the management interfaces 222, 224 may further comprise a real-time link to a video camera providing a view of the selected feature 214 and any construction or activity occurring at the selected feature 214.

The GDMS shown in FIGS. 1 and 2 is an innovative, GIS-based management decision support tool that optimizes the geo-processing and geo-visualization of available GIS data, for example, natural resources, building resources, time-management resources, personnel resources, financial resources, and information resources, and others. The GDMS may enable a GIS client to easily visualize and interpret large, multifaceted, and complex information sets in order to make comparative analyses of alternatives, identify potential liabilities and opportunities, and optimize program strategies.

The GDMS provides full convergence, or integration, of multiple (essentially limitless) disparate data sets within a single virtual three-dimensional (geospatial) model. The disparate data sets, and even sub-data sets within them, may be organized by association with relevant features on the model. For example, groundwater analytical data may be associated with a given groundwater well; building data may be associated with a given building; installation information may be associated with the installation; and command information may be associated with the command. The GDMS full data convergence allows data to be accessed relative to position, scale, resolution, time, and other geospatial attributes and serves as an extremely intuitive and efficient way to organize and access essentially limitless quantities of information.

The GDMS allows queries, filters, and comparisons of data to be completed at the GIS server system and then visually represented in three dimensions in near real time at the GIS client device. The three-dimensional representation of data helps users gain a better understanding of the meaning contained within the data more rapidly than using traditional tabular and/or two-dimensional representations of data. The GDMS thus allows the meaning represented in the three-dimensional data to be rapidly communicated to users.

The GDMS improves on traditional closed or organization-specific GIS by affording live connections to multiple databases. As the databases are updated, the representations afforded by GDMS can thus be current. This allows a fourth dimension, time, to be factored into resource management decisions. Time is an important additional data factor because previous “views” of the data can be compared to current “views” of the data, in order to gain an understanding of the rates of change (or dynamics) of the real system. In other words, the GDMS allows for differences between time states to be understood and factored into a decision process.

The GDMS 100 may be used to provide access to specific sections within documents which are associated with a particular geographic coordinate. More specifically, a GDMS 100 user (or GIS client) may select a specific location or ‘feature’ on a map and be directed to sections within documents, as well as entire documents themselves, which contain data or information relevant to that specific ‘feature’ selected. Said another way, specific relevant data may be provided to a user based upon the ‘feature’ selected, not just based upon a traditional search query. Thus, GDMS 100 links or ties a ‘feature,’ or specific geographic location, to an indexed database of data. Examples of documents that may have a geospatial associated, but are not amenable to layered geo-visualization may include real estate contracts concerning a particular property, title records, covenants, plats, zoning regulations, construction plans, and others. The specific relevant data provided to a user may comprise only portions or sections of documents, maps, or images related to that specific ‘feature’ selected. This may greatly increase efficiency of GIS by taking a user directly to a relevant section of a document, which may be hundreds or thousands of pages in length.

The GDMS may explicitly incorporate management goals and constraints, resulting in large reductions in initial capital and long-term organization and management costs in a wide range of resource management and workflow optimization projects. The GDMS also speeds the process of bringing discordant stakeholder groups to consensus by providing real-time and highly comprehensible (due to the visual output) answers to questions offered in meetings. For large projects, the total long-term savings to the user or client that results from the improved speed and precision of management decisions afforded by GDMS can amount to millions of dollars. Moreover, the technology introduced in the GDMS yields truly optimal solutions to highly complex and nonlinear physical problems using reasonable computational times and resources. The modular design of GDMS permits coupling to virtually any simulation code. The GDMS can also be linked to and implemented within user-friendly and widely-accepted graphical user interfaces (GUI's) including web browser applications.

As should be apparent from the above discussion, the GDMS is a powerful tool that may be used to access enormous quantities of data stored at remote locations. When using the GDMS, a security feature to control access to data stored at remote locations, for example, an access control module 222 as depicted in FIG. 2, may be implemented. The amount and nature of the data at the remote locations may be of a classified or confidential nature. Thus, it may be desirable for an administrator of the data stored at the remote location to have server-side control over varying levels of access to data. Thus, in some implementations, access control may be exercised on the server-side; however, in other implementations this level of access control may be exercised on the client side. Further, access control may also be exercised at/by a given database. It may also be desirable to have different levels of authorization to control data access for employees having different roles within an organization. For example, a higher level officer, such as a supervisor or general, may have unlimited access to classified data, while entry-level employees may only have access to non-classified data. These levels of authorization can be created and adjusted by an administrator to permit varying levels of access to the data.

The GDMS can specifically establish different levels of authorization for employees having different roles within the organization, such that the employee's level of permission determines which of the data or different layers of data and functionality an employee can view, access, or execute. For example, individuals having high level security clearances may be able to view and/or make changes to all savable layers viewable within a geospatial browser, while individuals having no security clearances may only be able to view non-classified layers of data and may not be able to make changes. The levels of access to the data may be controlled for each individual or may be controlled in groups (e.g., hierarchically) by the administrator and may be created and maintained using operations implemented within the access control module 222.

The varying levels of accessibility to data may be controlled using a number of different methods including, but not limited to, authentication codes and passwords, secure user management tools, firewalls, user authentication, user pathway mapping, and/or encryption. The levels of access control to the data may also be controlled by the creation of an individual profile for each user identifying the user's role in the organization and specifying their level of access to the data. Then, when a user logs onto a system, their level of access to data may be known by the system and the user may then only be able to view or access data that was commensurate with their level of authorization.

The layers of data may also be saved so that other authorized users can access the saved layers to view and make additional changes to (or comments on) the layers and then save those additional changes. This allows a given user to open the selected state, make changes, alterations, and comments, and save this new altered state for review and potential further modification by others. A GIS client can specifically establish different levels of authority for employees having different roles within the organization, such that the employee's level of access to data will determine which of the dynamically savable layers in a given state an employee can view or which tools are available for use in data selection and modification. In such implementations, certain GDMS view state data and/or functionality may or may not be accessible to and/or be editable by a user based upon access permissions that have been granted to or withheld from the user. For example, employee's having a high level security clearance may be able to view and/or make changes to the dynamically savable layers, while employee's having no security clearance may only be able to view non-classified layers of data, and may not be able to make changes. In another example, an individual having a high level of security may be able to execute all geospatially-referenced tools available within the GDMS system, while another with a lower level of security may be prevented from executing some or all of the tools.

In one implementation, access to the different map tiles or layers of data may be based upon the scale or resolution of the map or layer, i.e., access is ‘scale-driven.’ The contextual or ‘smart’ layers of data may be turned on or off by an administrator based upon the authorization to access each layer of data. For example, a user with a low security clearance level may only be able to view a few of the layers, while a user with a high security clearance level may be able to view many or all of the layers. In other implementations, different aspects, elevations, resolution, or features may be linked to the user's level of authorization, thus providing control over a user's level of access to these features. A user's ability to change or alter the layers of data may also be dependent upon their level of authorization or security clearance.

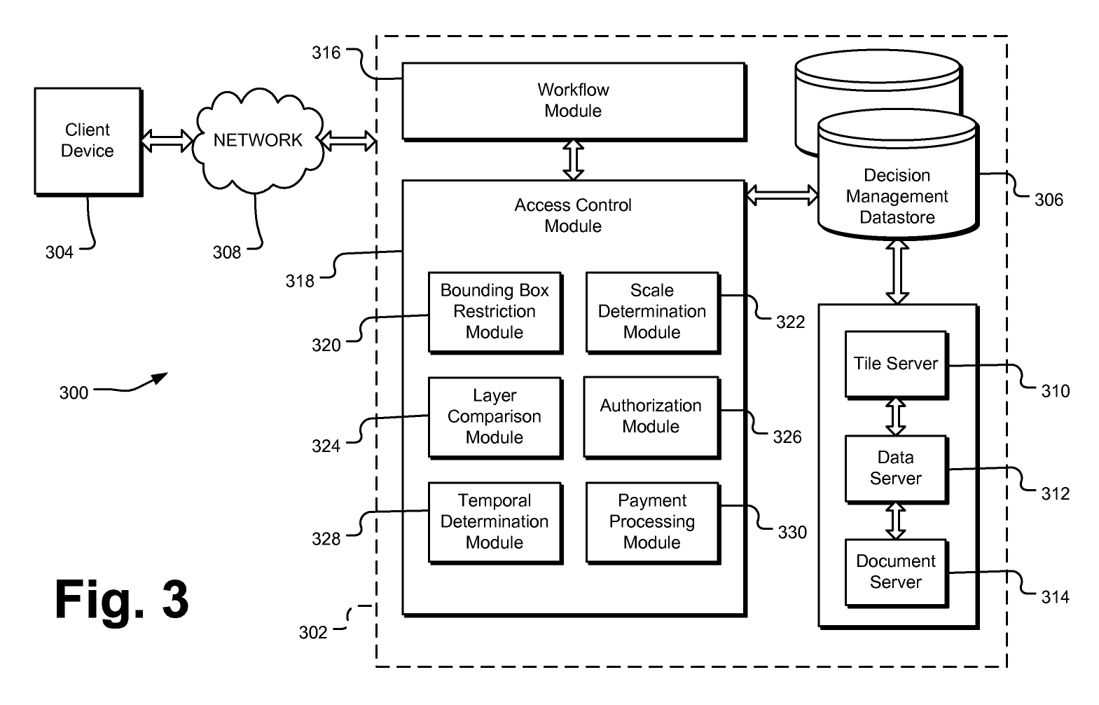

With reference now to FIG. 3, an exemplary GDMS 300 is implemented in a server system 302 with a DMD 306 as described above. The server system 302 may further include additional data servers, for example, a map tile server 310 indexed by coordinates, reference number, or feature; one or more layer servers 312 that provide feature and layer information also indexed by reference to geospatial coordinates, tile reference number, or feature; and a document server 314 that may provide documents and information associated with a geospatial location (again indexed by coordinate, reference number, or feature) in a format not amenable to geo-visualization. As shown in FIG. 3, the data servers 310, 312, 314 may be connected to the DMD 306 and/or to one another to maximize operating efficiency of the datastore 306. In some implementations, the data servers 310, 312, 314 and the datastore 306 may be located within the same server system 302, while in other implementations, the data servers 310, 312, 314 and the datastore 306 may be distributed across a network.

The server system 302 may further comprise a workflow module 316 and an access control module 318 through one or a number of different types of software programs (i.e., programming logic or computer executable instructions) utilizing a variety of different types of security measures to control access to the DMD 306. The workflow module 316 and the access control module 318 may be positioned between the client computer 304 and the DMD 306, as shown in FIG. 3, to provide a layer of access control between the client device 304 and the DMD 306 and/or the data servers 310, 312, 314. In other implementations, the access control module 318 and workflow module 316 may be partially or substantially implemented in other locations, for example, on the client device 304, or within the communications network 308.

In one implementation of the GDMS 300, as shown in FIG. 3, the access control module 318 and workflow module 316 may be separate from the DMD 306 and the servers 310, 312, 314. In other implementations, the access control module 318 and 310, 312, 314. The access control module 318 and workflow module 316, DMD 306, and data servers 310, 312, 314 are shown as separate components in FIG. 3 for simplicity of illustration, but may all be combined into one server system 302, system datastore, or network.

The access control module 318 and workflow module 316 may be operatively associated and may control access to different layers of data via the DMD 306 to facilitate control over what users can access through the DMD 306. The access control module 318 and workflow module 316 may work in concert to provide a security control function that grants or denies a user access to map tiles, information, documents, features, applications, resolution, elevation views, aerial extent views, and/or system access based on the user's identification. This also allows the DMD 306 to provide only the information, documents, features, and applications that are authorized and relevant to a given user, which may provide workflow efficiencies.

By streamlining user workflow, the availability of information and applications can be assigned by appropriate and relevant scale and/or resolution intervals. In this construct, application icons and information layers may appear and disappear based on the scale or resolution presented to the user within the system at any given point in time. This streamlines tasks by eliminating those information and application choices that are not relevant at a certain scale (and hence represent clutter) and by allowing more efficient navigation to the information and application choices that remain, i.e., those that are relevant at a given scale.

The workflow module 316 is a tool which may also lead users though data sets by progressively ‘walking’ a user through design steps using interactive design tools which may traverse more than one layer of data. The workflow module 316 may be particularly helpful for novice users as they attempt to navigate through the vast amounts of data accessible via the DMD 306. In one exemplary implementation, the features and functionality of the workflow module 316 may be turned on and off based upon the scale or resolution that a user attempts to access. In this embodiment, the workflow module 316 may operate by correlating the resolution or magnification of the geo-visualization data to conform to a user's level of authorization, thus controlling which users are able to view the most detailed or secure data.

The workflow module 316 may allow a system administrator to create within the DMD 306 different levels or groups of levels of access to the data for each individual within an organization. In this implementation, each individual within an organization may be given an individual profile. The individual profile may include information such as their role and/or security clearance within an organization. The individual profiles may be stored on a database coupled to, or integral with, the DMD 306. The profiles or lists of users may contain information on the level of information, or data, that each user is permitted to view. This individual profile may be accessed by the workflow module 316 and/or access control module 318 when individuals attempt to access data through the DMD 306 to permit the individual to have only a pre-determined level of access to data. When individuals attempt to access the DMD 306, their individual identities may be linked to their profile such that their access to the DMD 306 can be referenced and/or validated before they are permitted to access the DMD 306.

The workflow module 316 and access control module 318 may also allow system administrator of the DMD 306 to create and edit different levels of access to data for individuals or groups within an organization. For example, in the military, all individuals having equivalent rank or security clearance may have the same amount of access to the data within the datastore 306. Thus, the limited access is applied uniformly to the entire group of individuals, such that all of the individuals in the group have the same level of access to the data. This may be referred to as ‘hierarchical access control’ because groups or individuals may be grouped together for purposes of determining server-side access control levels.

Alternately, in an implementation of the GDMS 300 in an open or public platform, rather than a system internal to or controlled by a particular organization, access to data may be controlled based merely upon geospatial attributes, for example, the geospatial location (coordinates) of a tile request, scale of a tile request, resolution of a tile request, payment for access, the combination of layers requested, or freshness or staleness of data requested. Another example of a geospatial attribute may be the ability to download a geospatial dataset as opposed to merely having the ability to view a geo-visualization of such data, e.g., as a layer or set of features. A further example of a geospatial attribute may be the ability to save or bookmarks geo-visualization states defines by various combinations of underlying mar tiles and overlying layers and features for easily returning to such states as opposed to having to recreate the same filter query to return to a prior state. In such a public platform, contributors of GIS data accessible for geo-visualization may place limits or restrictions on the availability of or accessibility of the GIS data. A public implementation of the workflow module 316 may be used as an interface for data sources to either upload data to the DMD 306 or otherwise register data with the DMD 306 so that the DMD 306 can locate and access the data from a remote server or data store managed by the data source.

In order to place access restrictions on data, the data source may use the workflow module 316 to tag or otherwise encode an entire dataset or portions of the dataset with restriction instructions associated with one or more geospatial attributes. In one implementation, the workflow module 316 may provide tools to tag datasets, for example, using extensible mark-up language (XML) to indicate the presence and nature of a restriction tied to a particular map tile, data layer, or feature. In an alternate embodiment, a data source may encode a dataset itself as long as the tags are in a language and format that the DMD 306 understands.

As depicted in FIG. 3, the access control module 318 may be understood as composed of a number of functional sub-modules for implementing a public platform with controlled access to GIS data. Such sub-modules may include, for example, a bounding box restriction module 320, a scale determination module 322, a layer comparison module 324, a authorization module 326, a temporal determination module 328, and a payment processing module 330. Each of these modules may provide separate functionality, but often may operate in conjunction with each other to make an access control determination as further described below. It may be desirable to control access to data for a variety of reasons, for example, security concerns, proprietary concerns, or merely to generate revenue for a particular data source. In turn, a number of attributes or parameters associated with the GIS data may be used to filter requests for geo-visualization of the data and determine whether the request is subject to a restriction. The sub-modules represented in the access control module are exemplary only of possible schemes for restricting access to GIS data; other restriction parameters may be implemented as well, for example, based upon geospatial attributes.

The bounding box restriction module 320 within the access control module 318 may be used to provide a gross initial screening to determine whether a tile request by a user falls within the range of a bounding box that is entirely off-limits for presentation without a password or certificate due to proprietary or security concerns. For example, all satellite images of a military base in the desert conducting secret operations may be considered secret and unavailable to users without security clearance. However, the military may want to provide access to its database source in general for ease of distributed use among its own constituents through the GDMS as well as to provide the public access to non-classified maps and layer data. The bounding box restriction module 320 monitors all tile requests for GIS data to determine whether any of the requested tiles falls within a restricted bounding box. The bounding box may be also understood as defining a collection of records in a GIS database that have geospatial coordinate fields associated with the data with values falling within the range of the bounding box. An additional field in the data records may indicate whether there is a restriction placed on the data record and the nature of the restriction.

If a requested tile is restricted, then the bounding box restriction module 320 may interface with the DMD 306 and instruct that the requested GIS data or the tiles thereof that fall within the bounding box be withheld from delivery by the DMD 306 to the client 304. However, this access restriction may be overridden if the requestor can provide a valid password or certificate as further discussed below. The functions provided by the bounding box restriction module 320 may be used by the other modules within the access control module 318 in order to identify the geographic boundaries of a map tile request or data layer in order to determine whether other restrictions on access to a requested GIS dataset apply.

The scale determination module 322 may be used to control access to data based upon the scale and resolution of the GIS data requested. The term “scale” is used herein in the cartographic sense, e.g., 1 cm: 1 km (1 cm of the image presented on the screen corresponds to 1 km in real terms), whereas “resolution” refers to the sharpness of the image file available for presentation on the screen (e.g., the number of pixels or dots per inch in a raster image). A large scale, e.g., 1:1 generally will correspond to an image of high resolution whereas a small scale, e.g., 1:100,000 will generally correspond to an image of low resolution as there is a limited ability of a presentation screen to present a very high resolution at a small scale—there is physically no room. In the context of access control, it may be perfectly acceptable to provide map tiles of a particular coordinate area at a scale of 1 cm: 100 m at a relatively coarse resolution (e.g., 60 dpi), but it may be unacceptable to provide a larger scale (e.g., 1 cm:1 m) at a high resolution (e.g., 300 dpi), or at any resolution at all, due to security concerns or merely because that combination of scale and resolution has a premium value and is coded as inaccessible without payment of a fee.

The scale determination module 322 monitors requests for GIS data having a scale or resolution attribute. If there is a scale or resolution change requested, the scale determination module 322 may interface with the DMD 306 and request that the GIS data be held for screening by the scale determination module 322 to determine whether the requested GIS data has a scale or resolution restriction, or a combination thereof, and the nature of the restriction. For example, if the restriction is related to a security or proprietary concern, then the scale determination module 322 may instruct the DMD 306 to deny the request absent some further authorization provided by the requester. Alternatively, if the restriction is income driven, then the scale determination module 322 may instruct the DMD 306 to deny the request absent notification of payment for the premium service from the payment processing module 330.

The layer comparison module 324 may be used to control access to data based upon the types and combinations of data layers of the GIS data requested for overlay on a map. For example, it may be perfectly acceptable to provide a geo-visualization of a data layer showing locations of both surface reservoirs and groundwater reservoirs. However, if a user additionally requests a combination of information about the location of cyanide processing facilities in close proximity to surface reservoirs, the combination of such information may be considered a national security risk if the data layers presented would identify potential terrorist targets. The layer comparison module 324 may be built with logic to identify potentially problematic layer combination requests and may instruct the DMD 306 to deny the request absent some further authorization provided by the requestor. In a further implementation, the layer comparison module 324 may be configured to save identifying information of a user making a layer combination request with apparent adverse security implications, for example, in a watch list, and provide a notification or report to an administrator for possible additional investigation.

In each of the examples of geospatial attribute-driven access control presented above, it is noted that request denials of map tiles or data layers may be overridden by the provision of a valid certificate or password. The authorization module 326 provides an opportunity for requestors to enter a password, certificate, or other identification sufficient to overcome a denial of presentation of a requested map region, data layer, or feature. A data contributor may use the workflow module 316 to further password-protect or require certification before access to a dataset or portion of a dataset will be granted. Such data protection may be part of the tagging process described above. In some instances passwords and certifications associated with particular datasets may be held in the authorization module 326 for comparison to requester logins for GIS data. In such a case, if a requester enters the appropriate password or presents an appropriate certificate, the authorization module 326 may direct the DMD 306 to access and present the requested GIS data. In an alternate implementation, the contributor of a dataset with password/certification protection may maintain control over password verification and the role of the authorization module 326 is then to interface with the particular datastore, transfer the password/certification to the datastore, and receive approvals or denials of service to provide to the DMD 306.

Another exemplary function of the access control module 318 may be embodied in the temporal determination module 328 that allows or denies access to map tiles or layers based upon the age of the information comprising the particular dataset. For example, real-time satellite imagery or GPS information can be extremely valuable for weather forecasting, asset tracking, spying, and other uses. Because this information is so valuable, access may only be provided upon payment of a fee for such a premium service, or in the case of espionage data, the real-time data may not be accessible without a proper security clearance indicated by a password or certificate. Alternatively, information that is stale, i.e., days or weeks old may be worth little or pose no security threat as thus such stale information may be freely accessed. In another example, data that is significantly older may develop additional value again for use in temporal studies to identify trends. In such a case, the data may again only be accessible upon payment of a fee for the service. The temporal determination module 328 manages the temporal worth of GIS data, for example, by examining time stamps associated with particular GIS datasets and comparing the timestamps to any tags that may be encoded with the data indicating that the GIS dataset is subject to a fee for service within particular ranges of age.

A further exemplary function of the access control module 318 may be the acceptance of payment for access to GIS datasets through the payment processing module 330. Upon receipt of a request for a GIS dataset, the payment processing module 330 may query the relevant datastore to determine whether the dataset is subject to a fee for service. If so, the payment processing module 330 may instruct the DMD 306 to withhold delivery of a dataset to a requestor until payment is made. In an alternate implementation, the payment processing module 330 may maintain a schedule of fees charged by each contributor for particular datasets and compare incoming dataset requests with the schedule to determine whether a fee is required to access the data and instruct the DMD 306 accordingly. In another implementation, upon payment of a fee for access to a restricted dataset, the payment processing module 330 may issue a password or certification to the requester who would then present the password/certificate to the authorization module 326 to seek access to the dataset through that component. The payment processing module 330 may actually accept and process access payments from requesters, or it may interface with a third party payment processing service (e.g., PayPal®) to actually process fund transfers.

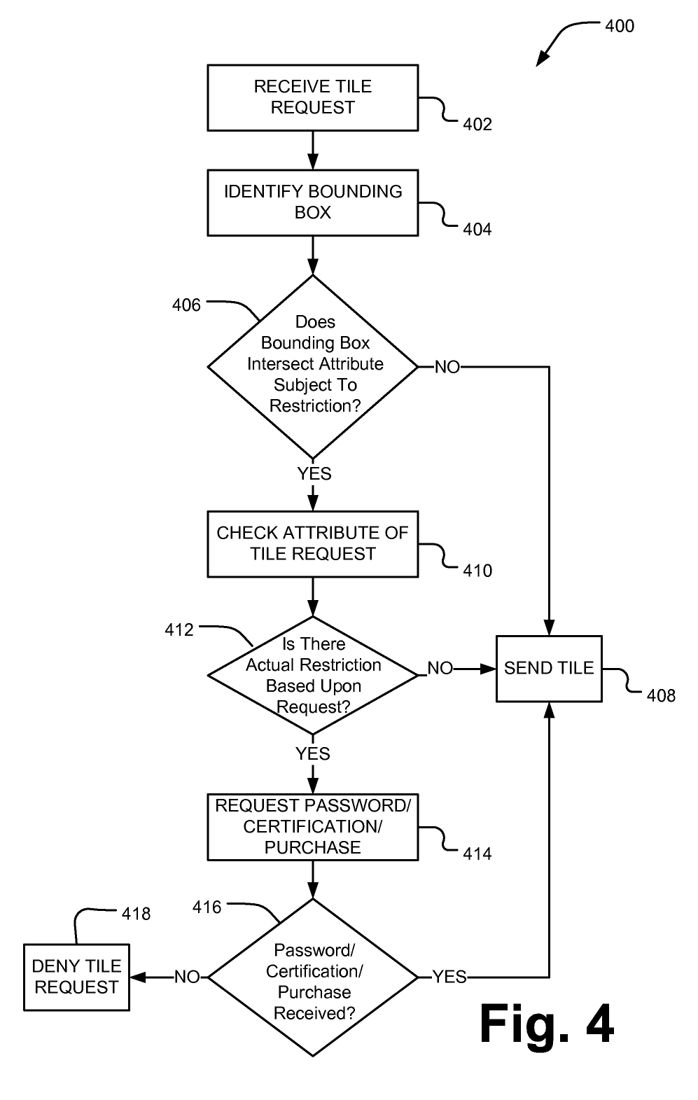

FIG. 4 depicts an exemplary set of access control operations 400 that may be performed according to one implementation of an access control module within a GDMS. Initially the access control module receives a tile request in a receiving operation 402. It should be understood that any request from a client device for GIS data, be it a particular map or a dataset for a layer or a feature or even a document, will necessarily be associated with one or more map tiles. In order to present a geo-visualization interface, all of the data must have a reference to particular geospatial coordinates which are generally broken down in units of map tiles.

Once a tile request is received, the access control module may next identify a bounding box containing all the tiles in the tile request in identification operation 404. Creation of a bounding box allows the access control module to easily determine whether access is restricted to presentation of any of the map tiles requested. In a comparison operation 406, the access control module may simply compare whether any of the entire region of the bounding box intersects with a geospatial attribute that may be subject to a presentation restriction. Recall that there can be any number of geospatial attributes that can be designated as having restriction requirements, for example, the geospatial location (coordinates) of a tile request itself, the scale of the tile request, resolution of a tile request, an angle of view (e.g., plan, aerial, street level, etc.), payment for access, the combination of layers requested, or the freshness or staleness of data requested. If there are no geospatial attribute restrictions associated with any of the tiles in the bounding box, the process 400 may approve all of the tiles and instruct the DMD to send the particular map tiles, layer dataset, features, or other information in sending operation 408.

If the access control module recognizes that there is a restriction associated with one or more of the tiles in the bounding box, the access control module may next determine what kind of geospatial attribute is implicated in the bounding box restriction in checking operation 410. The access control module may then invoke one or more of the sub-modules described above for further processing assistance. The appropriate sub-module(s) may first determine whether an actual restriction must be imposed on the data request pursuant to the geospatial attribute in determination operation 412. This operation determines whether the requested a value of the geospatial dataset or feature actually conflicts with the restriction set by the data contributor. For example, the tile request at a resolution value restricted by the data contributor without additional authorization or payment and the tile would be considered actually restricted. Alternatively, if the tile request is at a resolution value within the allowable bounds set by the contributor, then the attribute of the request would not be considered restricted and the tiles or associated data would be approved for presentation in sending operation 408.

If the geospatial attribute associated with the tile request is found to be “set high,” then the access control module will request that some form of authentication be presented by the requester before the data will be released for presentation in requesting operation 414. Responses to the requesting operation are then examined in determination operation 416 to determine whether access to the requested GIS dataset will ultimately be granted. For example, if the requester can provide a password or certification indicating that the requester has the necessary security clearance to access the requested GIS dataset, then the access control module will approve the request and the tile will be sent in sending operation 408. Similarly, if the GIS dataset is a premium service requiring additional payment, upon payment by the requester the access control module may approve the request and the tile will be sent in sending operation 408. If a requester cannot provide the appropriate password or certification, or chooses not to pay for a premium service, then the access controller will deny the tile request in denying operation 418. The GDMS may either inform the requester that the request has been denied or alternatively return a GIS data set as responsive as possible to the request, but without providing the restricted information. For example, if the resolution requested is restricted, the GDMS may return a dataset associated with tiles in the same geographic area as the bounding box, but at a lower, unrestricted resolution.

Some implementations described herein may be implemented as logical steps in one or more computer systems. The logical operations of the described systems, apparatus, and methods are implemented (1) as a sequence of processor-implemented steps executing in one or more computer systems and (2) as interconnected machine modules within one or more computer systems. The implementation is a matter of choice, dependent on the performance requirements of the computer system implementing the described system, apparatus, and method. Accordingly, the logical operations making up the implementations of the systems, apparatus, and methods described herein are referred to variously as operations, steps, objects, or modules.

In some implementations, articles of manufacture are provided as computer program products that cause the instantiation of operations on a computer system to implement the invention. One implementation of a computer program product provides a computer program storage medium readable by a computer system and encoding a computer program. Another implementation of a computer program product may be provided in a computer data signal embodied in a carrier wave by a computing system and encoding the computer program.

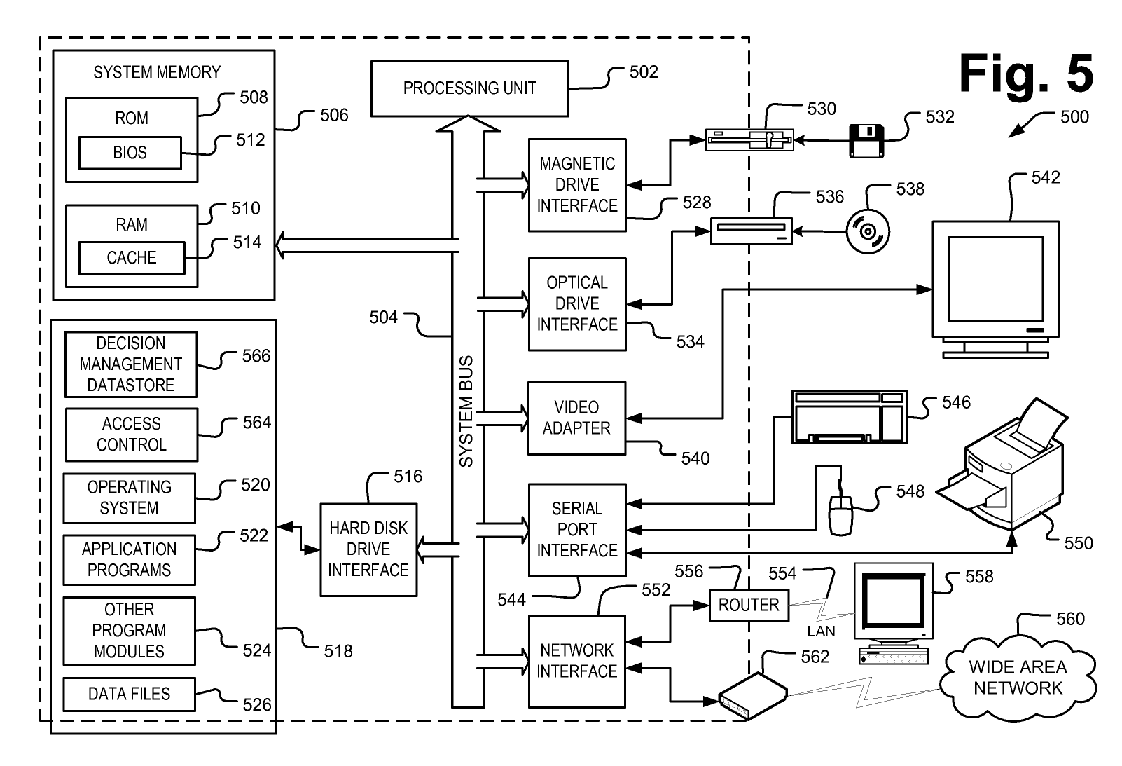

An exemplary computer system 500 for implementing the file origin determination processes above is depicted in FIG. 5. The computer system 500 may be a computer server with internal processing and memory components as well as interface components for connection with external input, output, storage, network, and other types of peripheral devices. Internal components of the computer system in FIG. 5 are shown within the dashed line and external components are shown outside of the dashed line. Components that may be internal or external are shown straddling the dashed line. Alternatively to a server, the computer system 500 may be in the form of any of a personal computer (PC), a notebook or portable computer, a tablet PC, a handheld media player (e.g., an MP3 player), a smart phone device, a video gaming device, a set top box, a workstation, a mainframe computer, a distributed computer, an Internet appliance, or other computer devices, or combinations thereof.

The computer system 500 includes a processor 502 and a system memory 506 connected by a system bus 504 that also operatively couples various system components. There may be one or more processors 502, e.g., a single central processing unit (CPU), or a plurality of processing units, commonly referred to as a parallel processing environment. The system bus 504 may be any of several types of bus structures including a memory bus or memory controller, a peripheral bus, a switched-fabric, point-to-point connection, and a local bus using any of a variety of bus architectures. The system memory 506 includes read only memory (ROM) 508 and random access memory (RAM) 510. A basic input/output system (BIOS) 512, containing the basic routines that help to transfer information between elements within the computer system 500, such as during start-up, is stored in ROM 508. A cache 514 may be set aside in RAM 510 to provide a high speed memory store for frequently accessed data.

A hard disk drive interface 516 may be connected with the system bus 504 to provide read and write access to a data storage device, e.g., a hard disk drive 518, for nonvolatile storage of applications, files, and data. A number of program modules and other data may be stored on the hard disk 518, including an operating system 520, one or more application programs 522, other program modules 524, and data files 526. In an exemplary implementation, the hard disk drive 518 may further store access control module 564 for restricting access to map and data files and the decision management datastore 566 for housing and managing GIS databases according to the exemplary processes described herein above. Note that the hard disk drive 518 may be either an internal component or an external component of the computer system 500 as indicated by the hard disk drive 518 straddling the dashed line in FIG. 5. In some configurations, there may be both an internal and an external hard disk drive 518.

The computer system 500 may further include a magnetic disk drive 530 for reading from or writing to a removable magnetic disk 532, tape, or other magnetic media. The magnetic disk drive 530 may be connected with the system bus 504 via a magnetic drive interface 528 to provide read and write access to the magnetic disk drive 530 initiated by other components or applications within the computer system 500. The magnetic disk drive 530 and the associated computer-readable media may be used to provide nonvolatile storage of computer-readable instructions, data structures, program modules, and other data for the computer system 500.

The computer system 500 may additionally include an optical disk drive 536 for reading from or writing to a removable optical disk 538 such as a CD ROM or other optical media. The optical disk drive 536 may be connected with the system bus 504 via an optical drive interface 534 to provide read and write access to the optical disk drive 536 initiated by other components or applications within the computer system 500. The optical disk drive 530 and the associated computer-readable optical media may be used to provide nonvolatile storage of computer-readable instructions, data structures, program modules, and other data for the computer system 500.

A display device 542, e.g., a monitor, a television, or a projector, or other type of presentation device may also be connected to the system bus 504 via an interface, such as a video adapter 540 or video card. Similarly, audio devices, for example, external speakers or a microphone (not shown), may be connected to the system bus 504 through an audio card or other audio interface (not shown).

In addition to the monitor 542, the computer system 500 may include other peripheral input and output devices, which are often connected to the processor 502 and memory 506 through the serial port interface 544 that is coupled to the system bus 506. Input and output devices may also or alternately be connected with the system bus 504 by other interfaces, for example, a universal serial bus (USB), a parallel port, or a game port. A user may enter commands and information into the computer system 500 through various input devices including, for example, a keyboard 546 and pointing device 548, for example, a mouse. Other input devices (not shown) may include, for example, a microphone, a joystick, a game pad, a tablet, a touch screen device, a satellite dish, a scanner, a facsimile machine, and a digital camera, and a digital video camera. Other output devices may include, for example, a printer 550, a plotter, a photocopier, a photo printer, a facsimile machine, and a press (the latter not shown). In some implementations, several of these input and output devices may be combined into a single device, for example, a printer/scanner/fax/photocopier. It should also be appreciated that other types of computer-readable media and associated drives for storing data, for example, magnetic cassettes or flash memory drives, may be accessed by the computer system 500 via the serial port interface 544 (e.g., USB) or similar port interface.

The computer system 500 may operate in a networked environment using logical connections through a network interface 552 coupled with the system bus 504 to communicate with one or more remote devices. The logical connections depicted in FIG. 5 include a local-area network (LAN) 554 and a wide-area network (WAN) 560. Such networking environments are commonplace in home networks, office networks, enterprise-wide computer networks, and intranets. These logical connections may be achieved by a communication device coupled to or integral with the computer system 500. As depicted in FIG. 5, the LAN 554 may use a router 556 or hub, either wired or wireless, internal or external, to connect with remote devices, e.g., a remote computer 558, similarly connected on the LAN 554. The remote computer 558 may be a PC client, a server, a peer device, or other common network node, and typically includes many or all of the elements described above relative to the computer system 500.

To connect with a WAN 560, the computer system 500 typically includes a modem 562 for establishing communications over the WAN 560. Typically the WAN 560 may be the Internet. However, in some instances the WAN 560 may be a large private network spread among multiple locations. The modem 562 may be a telephone modem, a high speed modem (e.g., a digital subscriber line (DSL) modem), a cable modem, or similar type of communications device. The modem 562, which may be internal or external, is connected to the system bus 518 via the network interface 552. In alternate embodiments the modem 562 may be connected via the serial port interface 544. It should be appreciated that the network connections shown are exemplary and other means of and communications devices for establishing a communications link between the computer system and other devices or networks may be used. Connection of the computer system 500 with a WAN 560 allows the decision management datastore 566 the ability to access remote GIS datastores to provide for a distributed GIS platform.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

Although various embodiments of this invention have been described above with a certain degree of particularity, or with reference to one or more individual embodiments, those skilled in the art could make numerous alterations to the disclosed embodiments without departing from the spirit or scope of this invention. And while the subject matter has been described in language specific to structural features and/or methodological arts, it is to be understood that the subject matter defined in the appended claims is not necessarily limited to the specific features or acts descried above. Rather, the specific features and acts described above are disclosed as example forms of implementing the claimed subject matter. It is intended that all matter contained in the above description or shown in the accompanying drawings shall be interpreted as illustrative only and not limiting. Changes in detail or structure may be made without departing from the basic elements of the invention as defined in the following claims.

What is claimed is:

1. A method in a computer system for controlling access to geospatial information system data accessible over a network, the method comprising
receiving a request for geospatial data associated with a geospatial map tile;
determining whether a geospatial attribute value associated with the geospatial map tile and defining the request is subject to a presentation restriction;
denying the request if the presentation restriction is determined to be an actual restriction applicable to the geospatial attribute value; and
approving the request if the presentation restriction is determined to be inapplicable to the geospatial attribute value.

2. The method of claim 1, wherein the determining operation further comprises
identifying a bounding box defining a collection of all geospatial map tiles associated with the request; and
approving the request if none of the collection of geospatial map tiles in the bounding box is subject to any presentation restriction.

3. The method of claim 2, wherein bounding box is defined by a collection of records in a geospatial database having coordinate fields corresponding to the collection of geospatial map files.

4. The method of claim 1, wherein
the geospatial attribute value corresponds to combinations of dataset layers; and
the determining operation further comprises
denying the request if the combination of data set layers is indicative of a an information combination implicating a security risk.

5. The method of claim 1, wherein
the geospatial attribute value corresponds to one or both of a scale or a resolution of the geospatial map tile; and
the determining operation further comprises
denying the request if the scale is smaller than a threshold scale defined by the presentation restriction, the resolution is higher than a threshold resolution defined by the presentation restriction, or a combination of both.

6. The method of claim 1, wherein
the geospatial attribute value corresponds to an age of the geospatial data; and
the determining operation further comprises
denying the request if the age of the geospatial data falls within a temporal period defined by the presentation restriction.

7. The method of claim 1, wherein when the presentation restriction is determined to be the actual restriction and the request is denied, the method further comprises
approving the request upon receipt of payment of a premium for access to the requested geospatial data.

8. The method of claim 1, wherein when the presentation restriction is determined to be the actual restriction and the request is denied, the method further comprises
approving the request upon receipt of an authorization for access to the requested geospatial data.

9. The method of claim 1 further comprising tagging the geospatial data with the presentation restriction.

10. A computer readable medium storing computer executable instructions for performing a computer process for controlling access to geospatial information system data accessible over a network, wherein the instructions comprise operations to
receive a request for geospatial data associated with a geospatial map tile;
determine whether a geospatial attribute value associated with the geospatial map tile and defining the request is subject to a presentation restriction;
deny the request if the presentation restriction is determined to be an actual restriction applicable to the geospatial attribute value; and
approve the request if the presentation restriction is determined to be inapplicable to the geospatial attribute value.

11. The computer readable medium of claim 10, wherein the operation to determine further comprises operations to
identify a bounding box defining a collection of all geospatial map tiles associated with the request; and
approve the request if none of the collection of geospatial map tiles in the bounding box is subject to any presentation restriction.

12. The computer readable medium of claim 11, wherein bounding box is defined by a collection of records in a geospatial database having coordinate fields corresponding to the collection of geospatial map files.

13. The computer readable medium of claim 10, wherein
the geospatial attribute value corresponds to combinations of dataset layers; and
the operation to determine further comprises an operation to
deny the request if the combination of data set layers is indicative of a an information combination implicating a security risk.

14. The computer readable medium of claim 10, wherein
the geospatial attribute value corresponds to one or both of a scale or a resolution of the geospatial map tile; and
the operation to determine further comprises an operation to
deny the request if the scale is smaller than a threshold scale defined by the presentation restriction, the resolution is higher than a threshold resolution defined by the presentation restriction, or a combination of both.

15. The computer readable medium of claim 10, wherein
the geospatial attribute value corresponds to an age of the geospatial data; and
the operation to determine further comprises an operation to
deny the request if the age of the geospatial data falls within a temporal period defined by the presentation restriction.

16. The computer readable medium of claim 10, wherein when the presentation restriction is determined to be the actual restriction and the request is denied, the instructions further comprise an operation to
approve the request upon receipt of payment of a premium for access to the requested geospatial data.

17. The computer readable medium of claim 10, wherein when the presentation restriction is determined to be the actual restriction and the request is denied, the instructions further comprise an operation to
approve the request upon receipt of an authorization for access to the requested geospatial data.

18. The computer readable medium of claim 10, the instructions further comprise an operation to tag the geospatial data with the presentation restriction.

19. A geospatial information system for controlling access to geospatial data accessible over a network comprising
a geospatial database that stores the geospatial data including geospatial map tiles;
an access control module that
receives a request for geospatial data associated with one or more of the geospatial map tiles;
determines whether a geospatial attribute value associated with the geospatial map tile and defining the request is subject to a presentation restriction;
denies the request if the presentation restriction is determined to be an actual restriction applicable to the geospatial attribute value by instructing the database not to output the geospatial data; and
approves the request if the presentation restriction is determined to be inapplicable to the geospatial attribute value by instructing the database to output the geospatial data.

20. The system of claim 19, wherein the access module further comprises a bounding box restriction module that
identifies a bounding box defining a collection of all geospatial map tiles associated with the request; and
approves the request if none of the collection of geospatial map tiles in the bounding box is subject to any presentation restriction.

21. The system of claim 20, wherein bounding box is defined by a collection of records in the geospatial database having coordinate fields corresponding to the collection of geospatial map files.

22. The system of claim 19, wherein
the geospatial attribute value corresponds to combinations of dataset layers; and
the access module further comprises a layer comparison module that denies the request if the combination of data set layers is indicative of a an information combination implicating a security risk.

23. The system of claim 19, wherein
the geospatial attribute value corresponds to one or both of a scale or resolution of the geospatial map tile; and
the access module further comprises a scale determination module that denies the request if the scale is smaller than a threshold scale defined by the presentation restriction, the resolution is higher than a threshold resolution defined by the presentation restriction, or a combination of both.

24. The system of claim 19, wherein
the geospatial attribute value corresponds to an age of the geospatial data; and
the access module further comprises a temporal determination module that denies the request if the age of the geospatial data falls within a temporal period defined by the presentation restriction.

25. The system of claim 19, wherein when the presentation restriction is determined to be the actual restriction and the request is denied, the access module further comprises a payment processing module that approves the request upon receipt of payment of a premium for access to the requested geospatial data.

26. The system of claim 19, wherein when the presentation restriction is determined to be the actual restriction and the request is denied, the access module further comprises an authorization module that approves the request upon receipt of an authorization for access to the requested geospatial data.

27. The system of claim 19 further comprising a workflow module that tags the geospatial data with the presentation restriction.
